(19) United States
(12) Patent Application Publication
(10) Pub. No.: US 2025/0361940 A1
(43) Pub. Date: Nov. 27, 2025

(54) VALVE FOR A PYROLYSIS SYSTEM

(71) Applicant: XYLO-CARBONE INC., St-Tite (CA)

(72) Inventors: Dominic LORD, Québec (CA); Antoine LANGLOIS, Saint-Jean-Port-Joli (CA); Simon LANGLOIS, Trois-Rivières (CA); Guy ST-AMANT, St-Tite (CA)

(21) Appl. No.: 18/987,324

(22) Filed: Dec. 19, 2024

Related U.S. Application Data
(60) Provisional application No. 63/652,101, filed on May 27, 2024.

(51) Int. Cl. F16K 3/02; F16K 3/18

(52) U.S. Cl. CPC F16K 3/0281; F16K 3/0227; F16K 3/0254; F16K 3/182

(57) ABSTRACT

A valve for a pyrolysis system for selectively opening and sealing a port of a retort chamber, having a valve body defining a discharge path and a closure member operable to open and close it. The closure member is displaceable relative to the valve body between an open and closed position along a displacement path transverse to the discharge path. A seal arrangement is between the valve body and the closure member, an actuation mechanism is operatively engaged to the closure member and configured to displace the closure member between the open and closed positions and to bias the closure member against the seal arrangement and/or the valve body in a direction along the discharge path. A gas conduit is configured for impinging pressurized air against a sealing area between the closure member and the valve body, with a gas outlet opened to the sealing area.

### CROSS-REFERENCE TO RELATED APPLICATION

The present application claims the priority of U.S. Patent Application Ser. No. 63/652,101, filed on May 27, 2024, the entire content of which is incorporated herein by reference . . .

### TECHNICAL FIELD

The present technology relates to systems for converting carboneous materials into biochar, and more particularly to valves for such systems.

### BACKGROUND

There exists a wide variety of systems for producing biochar, also known as biocoal. Typically, these systems heat batches of carboneous materials, such as wood chips, into kilns until the carboneous materials are turned into biochar with the desired properties. These systems include various components including valves and conduits to channel the carboneous materials through the system. require the handling of relatively large retorts that need to be placed and heated up in a kiln with low oxygen concentration, and then withdrawn and cooled down, which leads to increased production downtime.

Moving parts of the system, such as valves, are exposed to highly acidic conditions, high temperature, pressure, abrasion, dust and debris during the pyrolysis cycle. High temperature, pressure, abrasion, dust, debris and other contaminants may affect the longevity of components operating in such environment and/or affect the valve sealing.

### SUMMARY

In accordance with an aspect, there is provided a valve for a pyrolysis system, the valve configured for selectively opening and sealing a port of a retort chamber of the pyrolysis system, the valve comprising: a valve body defining a discharge path; a closure member operable to open and close the discharge path, the closure member displaceable with respect to the valve body between an open position and a closed position along a displacement path transverse relative to the discharge path; a seal arrangement between the valve body and the closure member; an actuation mechanism operatively engaged to the closure member, the actuation mechanism configured to displace the closure member between the open position and the closed position along the displacement path and, in the closed position, to bias the closure member against the seal arrangement and/or the valve body in a direction along the discharge path; and a gas conduit fluidly connectable to a pneumatic system and configured for impinging pressurized air against a sealing area between the closure member and the valve body, the gas conduit having a gas inlet fluidly upstream of a gas outlet, the gas outlet opened to the sealing area.

In accordance with another aspect, there is provided a valve for a pyrolysis system, the valve configured for selectively opening and sealing a port of a retort chamber of the pyrolysis system, the valve comprising: a valve body defining a discharge path; a closure member operable to open and close the discharge path, the closure member displaceable with respect to the valve body between an open position and a closed position along a displacement path transverse relative to the discharge path; a seal arrangement between the valve body and the closure member; an actuation mechanism operatively engaged to the closure member to actuate the closure member between the open position and the closed position; and a gas conduit fluidly connectable to a pressurized gas source and configured for impinging pressurized gas against a sealing area between the closure member and the valve body prior to the closure member gaining the closed position to flush debris from the sealing area, the gas conduit having a gas inlet fluidly upstream of a gas outlet, the gas outlet opened to the sealing area.

In accordance with another aspect, there is provided a valve for a pyrolysis system, the valve configured for selectively opening and sealing a port of a retort chamber of the pyrolysis system, the valve comprising: a valve body defining a discharge path; a closure member operable to open and close the discharge path, the closure member displaceable with respect to the valve body between an open position and a closed position along a displacement path transverse relative to the discharge path; a seal arrangement between the valve body and the closure member, the seal arrangement including a scraper frictionally engaging at least one of the closure member and the valve body in a sealing area about the discharge path during the displacement of the closure member between the closed position and the open position; and an actuation mechanism operatively engaged to the closure member to actuate the closure member between the open position and the closed position; and a plurality of gas conduit fluidly connectable to a pressurized gas source and configured for impinging pressurized gas against the sealing area to flush debris therefrom, the gas conduit having a gas inlet fluidly upstream of a gas outlet, the gas outlet opened to the sealing area.

Further in accordance with the above aspects, for example, the closure member includes a panel defining an opening therethrough, the opening aligned with an inlet opening of the valve body when the closure member is in the open position.

Further in accordance with the above aspects, for example, the seal arrangement includes a first seal interfacing between the valve body and the closure member, wherein the first seal is annular and extends along a full periphery of the discharge path, the first seal compressible between the valve body and the closure member.

Further in accordance with the above aspects, for example, the seal arrangement includes a second seal closer to the discharge path than the first seal, the first seal and the second seal are concentric one with respect to the other.

Further in accordance with the above aspects, for example, the first seal is located in a recess of the valve body.

Further in accordance with the above aspects, for example, the outlet of the gas conduit is situated between the first seal and the second seal.

Further in accordance with the above aspects, for example, the valve includes a plurality of gas conduits, including the gas conduit, the plurality of gas conduits having gas outlets distributed along the periphery of an inlet opening of the valve body.

Further in accordance with the above aspects, for example, the actuation mechanism includes: at least a first actuator for causing a linear displacement of the closure member between the open position and the closed position along the displacement path, the first actuator coupled to the valve body at one end and to the closure member at an opposite end; and at least a pair of second actuators configured to bias the closure member against the seal arrangement and/or the valve body in a transverse direction with respect to the displacement path.

Further in accordance with the above aspects, for example, the first actuator is part of a pair of first actuators, the pair of first actuators and the pair of second actuators are located on opposite sides of the closure member, the pair of first actuators and the pair of second actuators mounted to the valve body.

Further in accordance with the above aspects, for example, the first actuator extends longitudinally in a direction that is generally parallel to the displacement path.

Further in accordance with the above aspects, for example, the actuation mechanism includes a plurality of rollers operatively engaged to the closure member, the plurality of rollers in rolling engagement with the closure member as the closure member displaces with respect to the valve body between the open position and the closed position along the displacement path.

Further in accordance with the above aspects, for example, the closure member includes rails on opposite sides of the closure member and cooperating with the plurality of rollers to guide the displacement of the closure member between the open position and the closed position, the rails engaged with the plurality of rollers.

Further in accordance with the above aspects, for example, the closure member is suspended with respect to the valve body via the pair of second actuators.

Further in accordance with the above aspects, for example, the pair of second actuators is a first pair of second actuators, the actuation mechanism includes a second pair of second actuators, the first and second pairs of second actuators are located on opposite sides of the closure member, the support brackets are located on opposite sides of the closure member, each support bracket coupled to a respective one of the first and second pairs of second actuators.

Further in accordance with the above aspects, for example, the pair of second actuators are pivotally engaged to linkages, the linkages pivotally mounted to the valve body and having a pivot axis normal to the displacement path, the pair of second actuators operable to pivot the linkages as the pair of second actuators are operated to bias the closure member against the seal arrangement and/or the valve body.

Further in accordance with the above aspects, for example, each second actuator of the pair of second actuators are mounted in a floating configuration between two of the linkages, a first end of each second actuator of the pair of second actuators is mounted to a respective one of the linkages, and a second end of each second actuator of the pair of second actuators is mounted to another respective one of the linkages.

Further in accordance with the above aspects, for example, a ratio of elongation of the first actuator with respect to a displacement of the closure member along the displacement path from the open position to the closed position is 1:1.

Further in accordance with the above aspects, for example, the scraper is biased towards the closure member via a first seal of the seal arrangement, the first seal interfacing between the valve body and the scraper, the scraper including a ring located in a recess of the valve body, the ring extending about an inlet opening of the valve body, the first seal compressible between the ring and the valve body when the valve gains the closed position.

Further in accordance with the above aspects, for example, the sealing area has an annular shape, the sealing area extending outwardly from a periphery of the inlet opening to an outwardmost end of the first seal.

Further in accordance with the above aspects, for example, the valve body includes guides to guide the closure member along the displacement path, the guides extending along sides of the valve, on opposite sides of the closure member.

Further details of these and other aspects of the subject matter of this application will be apparent from the detailed description included below and the drawings.

### DESCRIPTION OF THE DRAWINGS

Reference is now made to the accompanying drawings.

FIG. 1 is a perspective view of a pyrolysis system in accordance with an embodiment of the present technology.

FIG. 2 is a rear elevation view of a portion of the pyrolysis system of FIG. 1 including a kiln and a retort.

FIG. 3 is a cross-sectional view of the portion of the pyrolysis system of FIG. 2 taken along cross-section line 3-3 of FIG. 2.

FIG. 4 is a perspective view of a valve of the pyrolysis system of FIGS. 1-3, in an open position, in accordance with an embodiment.

FIG. 5 is a side elevation view of the valve of FIG. 4.

FIG. 6 is another perspective view of the valve of FIG. 4, in a closed position.

FIG. 7A is a partial perspective view of the valve of FIG. 6 showing components of an actuation mechanism of the valve in the closed position.

FIG. 7B is a side elevation view of the valve of FIG. 6 showing components of an actuation mechanism in the closed position.

FIG. 8 is a schematic cross-section view of the valve of FIG. 6 in a sealed configuration.

FIG. 9 is a schematic cross-section view of the valve of FIG. 6, showing portion D of FIG. 8, in one configuration.

FIG. 10 is a schematic cross-section view of the valve of FIG. 6, in a closed position prior to sealing.

FIG. 11 is a perspective view of a valve of the pyrolysis system of FIGS. 1-3, in an open position, in accordance with an embodiment.

FIG. 12 is a perspective view of the valve of FIG. 11, in a closed position.

FIG. 13 is an exploded perspective view of the valve of FIG. 11.

FIG. 14 is a partial perspective view of the valve of FIG. 11, showing components of the valve of FIG. 11.

FIG. 15 is a front elevation view of the valve of FIG. 11 in an unsealed configuration.

FIG. 16 is a schematic cross-section view of a sealing area of the valve of FIG. 11 in a sealed configuration.

FIG. 17A is a perspective view of a variant of the valve of FIGS. 11-16 embodiment.

FIG. 17B is a perspective view of part of the variant of the valve of FIG. 17A.

FIG. 17C is a side elevation view of the part of FIG. 17B.

### DETAILED DESCRIPTION

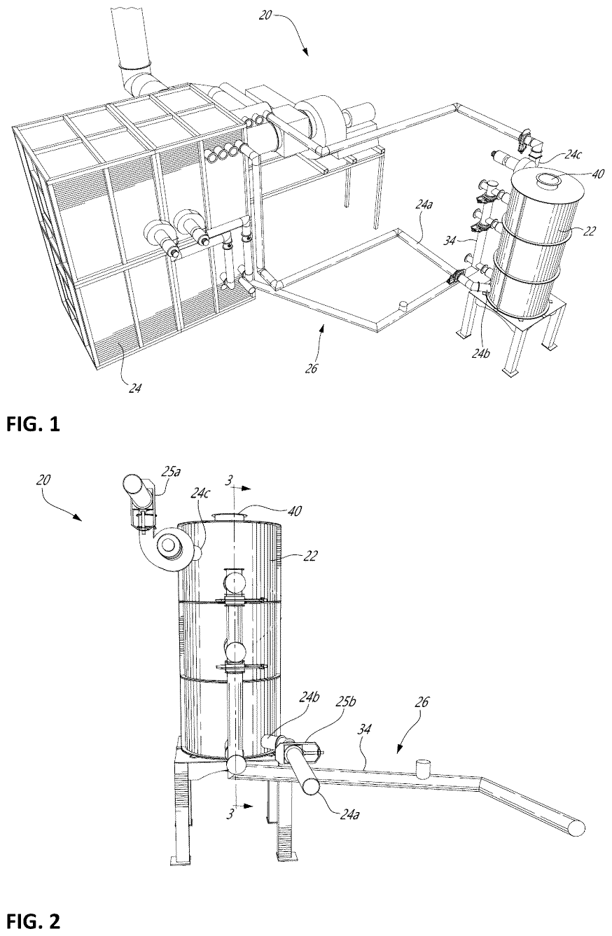

FIGS. 1-3 illustrate an exemplary pyrolysis system 20. The pyrolysis system 20 is adapted for producing biochar from carboneous materials including, and not limited to, wood chips and agricultural waste products and other organic materials. The pyrolysis system 20 is adapted for converting the carboneous materials into biochar having a carbon content ranging from 70%-wt to 93%-wt. The pyrolysis process (also referred to as thermo-conversion) occurs in the pyrolysis system 20 by controlling, among other parameters, the temperature, atmosphere, moisture content, residence time and pressure undergone by the carboneous materials. For instance, in some embodiments, the temperature is generally comprised between 300° C. and 600° C., depending on, among various parameters, the residence time of the carboneous materials. Such a pyrolysis system 20 is described in US patent application publication no. 2024/0018417, the entire content of which is incorporated herein by reference.

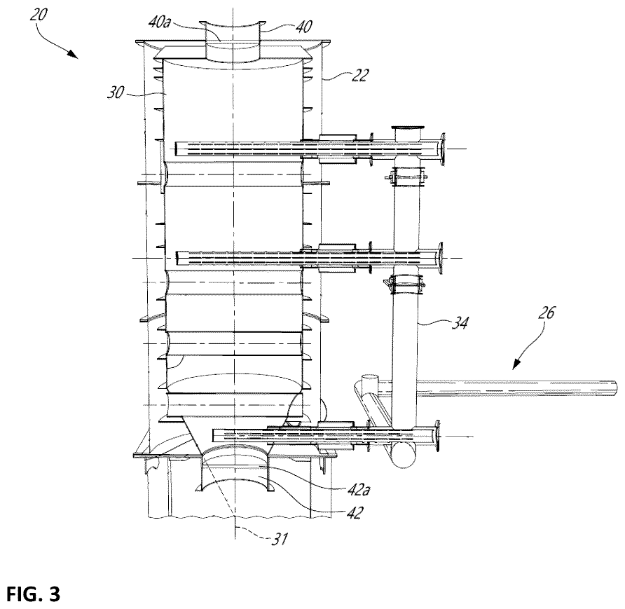

In the embodiment shown, the pyrolysis system 20 includes a kiln 22 adapted for containing hot air and/or other hot gases supplied by a combustor 24 that is part of a gas recovery system 26. A hot air line 24a is fluidly connected from the combustor 24 to the kiln 22 for supplying the hot air and/or other hot gases to an inner volume of the kiln 22. The combustor 24 includes a burner (not shown) adapted to burn suitable fuel(s), such as propane, and/or pyrolysis gases and residues, such as syngas, tarry by-products, phenolics and bio-oil, generated during the thermo-conversion of the carboneous materials and recovered by the gas recovery system 26. The combustor 24 operates under vacuum and at a temperature ranging between 500° C. and 1000° C. In one example, the hot air may enter the kiln 22 at a hot air inlet 24b through a hot air inlet valve 25a at a temperature of about 700° C. The hot air exits the kiln 22 at a hot air outlet 24c through a hot air outlet valve 25b at a temperature of about 300° C. A retort 30 (FIG. 3) is located inside the kiln 22 and is affixed to the kiln 22. The retort 30 defines a chamber 32 in which the carboneous materials are placed for pyrolysis and converted into biochar. The retort 30 is affixed to the kiln 22 using suitable fasteners and/or suitable bonding techniques, such as welding. The retort 30 and the kiln 22 define a longitudinal, vertical axis 31 (FIG. 3) extending in a center of the kiln 22 and the retort 30. The gas recovery system 26 further includes a conduit 34 fluidly connected between the chamber 32 of the retort 30 and the combustor 24. The conduit 34 conveys the pyrolysis gas and residues from the chamber 32 of the retort 30 to the combustor 24 for combustion thereof, which may improve the overall efficiency of the pyrolysis system 20 in some circumstances. The retort 30 is configured for indirect heat transfer from the hot air flowing inside the kiln 22 to the carboneous materials located inside the chamber 32 of the retort 30. Furthermore, the retort 30 and the gas recovery system 26 are adapted to isolate the carboneous materials from direct contact with the hot air flowing inside the kiln 22.

The retort 30 includes an inlet 40 for filling the chamber 32 of the retort 30 with the carboneous materials. An air-tight, high-temperature inlet valve 40a is located in the inlet 40 to hermetically seal off the chamber 32 upon closing the inlet valve 40a. The retort 30 further includes an outlet 42 located vertically below the inlet 40 for emptying the biochar from the chamber 32 through gravity. An air-tight, high-temperature outlet valve 42a is located in the outlet 42 to hermetically seal off the chamber 32 upon closing the outlet valve 42a. For filling the chamber 32 with the carboneous materials, the outlet valve 42a is closed and the inlet valve 40a is open so as to allow passage to carboneous materials flowing from above the retort 30 and kiln 22. For emptying the chamber 32, the outlet valve 42a is opened and the biochar is allowed to flow underneath the retort 30 and kiln 22. The outlet 42 is spaced from a ground surface, and it is contemplated that, upon opening the outlet valve 42a, the biochar is collected into a suitable container or on a conveyor belt system carrying the biochar away for further processing. It is also contemplated that, in some embodiments, the pyrolysis system 20 has the capability to introduce airflow at the end of the pyrolysis cycle while the biochar is still hot to force the adsorption of oxygen into the porous structure of the biochar and improve its resistance to self-heating. Self-heating occurs when there is a chemical reaction between the biochar and the oxygen present in the air without an external source of heat. Self-heating depends on many parameters, such as and not limited to, the moisture content of the biochar, the particles size, and the surface in contact with the air.

For instance, the inlet valve 40a can be cracked open to allow flow of air (and oxygen) inside the chamber 32 of the retort 30 at the end of a cycle. During this post-treatment phase, the gases are still sucked into the combustor 24 to eliminate gas emission outside the pyrolysis system 20. Under certain conditions, the input of oxygen inside the chamber 32 of the retort 30 permits burning of at least some pyrolysis gas and residues, thus promoting the formation of biochar with desirable properties. For examples, the oxygenation produced by the inlet valve 40a being opened may improve the resistance to self-heating.

During operation of the system 20, the valves 40a, 42a are exposed to a harsh environment, including high temperature, acidic fluids, dust, debris and other contaminants. These operating conditions may affect the longevity of the components, and require regular maintenance. In addition, the presence of dust, debris and other contaminants in the vicinity of the valve moving parts and its sealing interface may affect the sealing capability of such valves over repeated pyrolysis cycles.

The valves 40a, 42a will now be described in accordance with various embodiments, referring to the following figures.

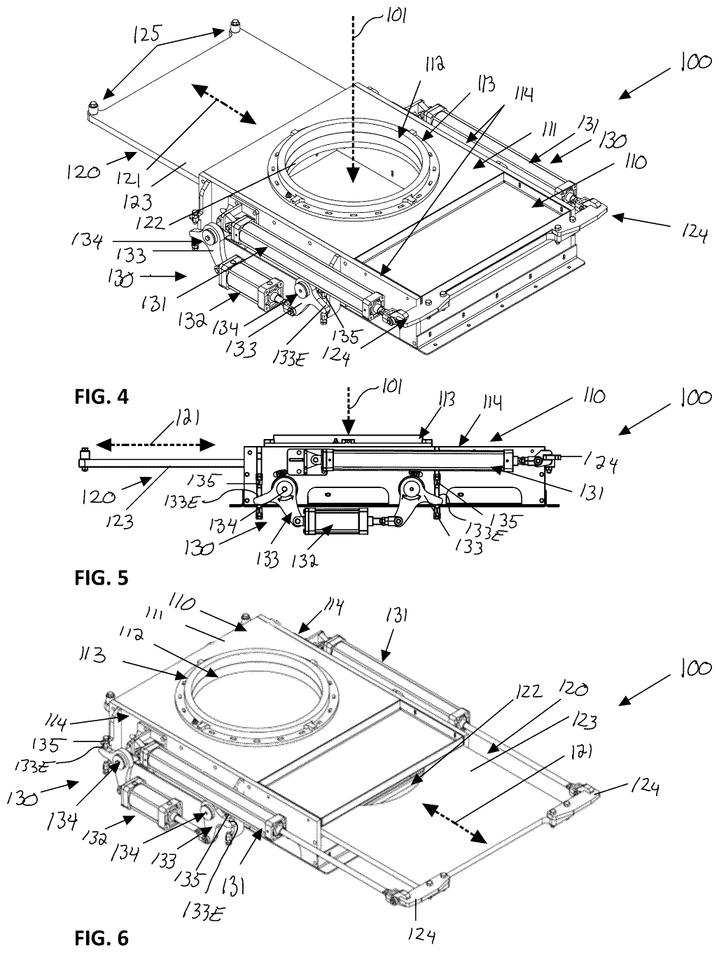

Referring to FIGS. 4-10, a valve 100 for a pyrolysis system such as the system 20 is now described. In at least some applications, the valve 100 is configured to selectively open and seal a port of the retort 30 for carboneous materials fed thereinto for processing into biochar.

In FIG. 4, the valve 100 is shown in an open position. A discharge path is identified at 101. The discharge path 101 is the path through which materials can pass to transit between two sections of the system 20, a section upstream of the valve 100 and a section downstream of the valve 100. In FIG. 4, the upstream section is situated above the valve 100, whereas the downstream section is situation under the valve 100. It is understood that, as part of the system 20, the valve 100 may be oriented so as to have the discharge path 101 at the vertical. Other orientations are possible (e.g., angled relative to the vertical). The valve 100 may be located downstream of the retort 30, such as the valve 42a. As part of the system 20, the valve 100 may be referred to as the lower valve.

The valve 100 includes a valve body 110. The valve body 110 may include a plurality of parts, such as plates, channels, bars, brackets, etc. The parts of the valve body 110 may be assembled via fasteners, welding, or the like. The valve body 110 may be mounted to other components of the system 20, such as the kiln 22 or retort 30. In an embodiment, the valve body 110 may be mounted at the outlet 42 of the retort 30 (the conduit or section of the retort 30 defining the outlet). The discharge path 101 may thus be downstream of, and in continuity with, the outlet 42 of the retort 30. In some embodiments. The valve body 110 may be mounted at an end of a conveyor (e.g., screw conveyor) or hopper that may be immediately downstream of the valve 100. In such case, the valve 100 may be supported by the conveyor structure or hopper, if present.

The valve body 110 includes a base 111. In the embodiment shown, the base 111 is plate like. The valve body 110 defines an inlet opening 112. In the embodiment shown, the inlet opening 112 is defined by a ring 113 coupled to the base 111. The ring 113 has a generally circular shape. Other shapes could be contemplated (e.g., oval, square, etc.). The ring 113 forms part of the valve body 110. The ring 113 and the base 111 could be formed as a single part. In some embodiments, the ring 113 has a shape that generally correspond to the cross-section of the conduit to which it is coupled. The inlet opening 112 may have a cross-section with a shape that corresponds to that of the ring 113.

The valve body 110 defines guides 114 to guide the movement of a closure member 120 of the valve 100. In the embodiment shown, the guides 114 are defined by generally straight parts extending along sides of the valve 100. The guides 114 are generally parallel to each other and extend on opposite sides of the closure member 120 (and base 111). In the embodiment shown, the guides 114 are plates that form the base structure of the valve 100 with the base 111. In at least some embodiments, the guides 114, may includes rails, channels, or other guiding members cooperating with the closure member 120 (or components thereof) to guide the reciprocating movement of the closure member 120 between the open position and a closed position. Components of an actuation mechanism 130 (described later) of the valve 100 are mounted to the guides 114. In variants, as described later, the guides 114 may be part of the closure member 120, and the valve body 110 may include features engaging the guides of the closure member 120 to allow the displacement of the closure member 120 relative to the valve body 110.

With continued reference to FIG. 4, the closure member 120 is operable to open and close the discharge path 101. The closure member 120 is displaceable with respect to the valve body 110, along the base 111. The closure member 120 is displaceable between the guides 114, between an open position and a closed position along a displacement path 121 transverse relative to the discharge path 101. In the embodiment shown, the closure member 120 has an opening 122. The opening 122 generally aligns with the inlet opening 112 when the closure member 120 is in the open position. The opening 122 may have the same cross-section (shape and/or dimension) as that of the inlet opening 112. In variants, the opening 122 may be greater than the inlet opening 112. In the embodiment shown, the opening 122 has a round/circular shape. Other shapes could be contemplated (e.g., same shape or different shapes as that of the inlet opening 112). In the embodiment shown, the closure member 120 includes a generally flat panel 123, or gate. Such panel 123 extends lengthwisely in a direction that is parallel to the guides 114 of the valve body 110. In the embodiment shown, the opening 122 is defined through the panel 123. As shown, the panel 123 has panel sections extending on opposite sides of the opening 122. A first panel section extends from a first end of the panel 123 to the opening 122, and a second panel section extends from a second end (opposite to the first end) to the opening 122. The first and second panel sections may have the same length or different length. Stated otherwise, the opening 122 may be located in a center of the panel 123, though this is only one example. The first and second panel sections may be interconnected by panel segments extending along the opening 122. Such panel segments may delimit the opening 122, on opposite sides of the opening 122, along the guides 114. The first and second panel sections, and the panel segments may all form an integral part of the panel 123, or separate parts that are connected together to form parts of the panel 123, in some variants.

In the embodiment shown, the closure member 120 includes a coupling 124 that is configured to connect with the actuation mechanism 130 of the valve 100. The coupling 124 extends at one of the ends of the panel 123. The coupling 124 could be an integral part of the panel 123, or a separate part that is coupled thereto. For example, in an embodiment, the coupling 124 may be fastened to the panel 123. In the embodiment shown, the coupling 124 includes a pair of brackets coupled to the panel 123, at an end thereof. The brackets extend in a widthwise direction relative to the length of the panel 123. The brackets projects on opposite sides of the panel 123. The brackets are configured to be coupled with the actuation mechanism 130. Holes, interlocking, pins, or a complementary connector may be defined by or engage with the actuation mechanism 130. The coupling 124 could have a different configuration in some variants. While the coupling 124 is described herein as part of the closure member 120, the coupling 124 could form part of the actuation mechanism 130. In both cases, the coupling 124 is adapted to interconnect the closure member 120 and the actuation mechanism 130 for operation of the closure member 120.

In the embodiment shown, the closure member 120 includes one or more stoppers 125. The stoppers 125 are located at the end of the closure member 120 that is opposite to the end of the coupling 124. The stoppers 125 may be configured to provide a mechanical interference with the valve body 110 when the closure member 120 is in the closed position. The stoppers 125 may act as fail safe, end of travel, components of the closure member 120. When the closure member 120 has reached the closed position, the stoppers 125 may abut against the valve body 110 In some embodiments, the stoppers 125 may act as visual indicators to ensure that the opening 122 of the closure member 120 is correctly aligned with the inlet opening 112 when the closure member 120 is operated to gain the closed position. The stoppers 125 are optional.

With continued reference to FIG. 4 and additional reference to FIGS. 5-6, the actuation mechanism 130 of the valve 100 will now be described. In the embodiment shown, the actuation mechanism 130 includes a plurality of actuators configured to operate the closure member 120. The actuation mechanism 130 is operatively engaged to the closure member 120 and configured to displace the closure member 120 between the open position and the closed position along the displacement path 121 and, in the closed position, to bias the closure member 120 against a seal arrangement 140 (described later) of the valve 100 in a direction along the discharge path 101. The plurality of actuators may be linear actuators, as shown. In an embodiment, the plurality of actuators are pneumatic actuator. Other types of actuators may be contemplated, such as hydraulic actuators.

In the embodiment shown, the actuation mechanism 130 includes a first pair of actuators 131 located on opposite sides of the closure member 120. The first pair of actuators 131 are mounted to the valve body 110. As shown, the first pair of actuators 131 are coupled to the guides 114. The actuators 131 may be coupled to the valve body 110 via suitable brackets. For example, in the embodiment shown, a base end of the actuators 131 is coupled to the valve body 110. An opposite displaceable end (piston rod end) of the actuators 131 is coupled to the coupling 124 of the closure member 120. In operation, the actuators 131 simultaneously operate the closure member 120. Both actuators 131 may induce the reciprocating movement of the closure member 120 along the displacement path 121, between the open position and the closed position. The actuators 131 could be mounted reversely with the piston rod end coupled to the valve body 110 and the base end coupled to the coupling 124.

In the embodiment shown, the actuators 131 extend longitudinally in a direction that is generally parallel to the displacement path 121. The actuation direction may thus be generally aligned with the reciprocating movement of the closure member 120. In an embodiment, such as shown, the actuators 131 and their actuation direction extend in a same plane as the panel 123, i.e., they are coplanar. In variants, the actuators 131 may not be coplanar with the panel 123 (e.g., non-parallel and/or non-coplanar).

In FIGS. 4-5, the closure member 120 is in the open position. The open position of the closure member 120 may be gained and/or maintained without pressurized gas supplied to the actuators 131 by the pressurized gas source (not shown). The actuators 131 may not apply any load on the closure member 120 to maintain the closure member 120 in the open position. This may be considered as a safety measure for the pyrolysis system.

As the actuation mechanism 130 is operated to displace the closure member 120 in the closed position, the closure member 120 displaces along the guides 114. The actuators 131 extends in their extended position so as to displace the piston rod end of the actuators 131. A corresponding displacement of the closure member 120 is induced. In the embodiment shown, the linear displacement of the closure member 120 from the open position to the closed position is directly correlated, with the elongation of the actuators 131. A ratio of elongation of the actuators 131 with respect to the displacement of the closure member 120 along the displacement path 121 is 1:1. Other ratios could be contemplated in variants of the actuation mechanism 130.

In order to seal the valve 100, the actuation mechanism 130 is configured to bias the closure member 120 against a seal arrangement 140 (FIG. 8, described later) of the valve 100 in a direction along the discharge path 101. With reference to FIGS. 4-5, the actuation mechanism 130 includes a second pair of actuators 132 operatively engaged to the closure member 120. The second pair of actuators 132 may be operated simultaneously so as to bias the closure member 120 against the seal arrangement 140 (FIG. 8).

In operation, in an embodiment, the second pair of actuators 132 may be operated simultaneously with the first pair of actuators 131. As such, as the first pair of actuators 131 are operated to displace the closure member 120 from the open position to the closed position, the second pair of actuators 132 may initiate the sealing operation of the valve 100. The actuators 132 of the second pair of actuators 132 are mounted in a floating configuration. The opposite ends of the actuators 132 are pivotally coupled to respective linkage 133. As shown, the base end of the actuators 132 and the piston rod end of the actuators 132 are coupled to respective linkages 133. In the embodiment shown, the linkages 133 has a bellcrank lever shape. The piston rod end is coupled to one end thereof at a distance from a pivot 134. As the valve 100 gains the sealed configuration, the elongation of the actuators 132 causes a rotation of the linkages 133 about the pivot 134. As shown, the linkages 133 are pivotally coupled to the valve body 110. The linkages 133 are coupled to the guides 114 via the pivot 134. The pivot 134 has a pivot axis extending transversely with respect to the displacement path 121. In the embodiment shown, the pivot axis is normal to the displacement path 121. The pivot axis is also normal to the elongation direction of the actuators 132. A free end 133E of the linkage 133 may abut against an abutment 135 when the valve 100 gains the sealed configuration. Such abutment 135 may serve as a mechanical stopper for the travel of the actuators.

The linkages 133 are described with respect to one of the sides of the valve 100, though it should be understood that the linkages 133 may be mirrored on the other side of the valve 100.

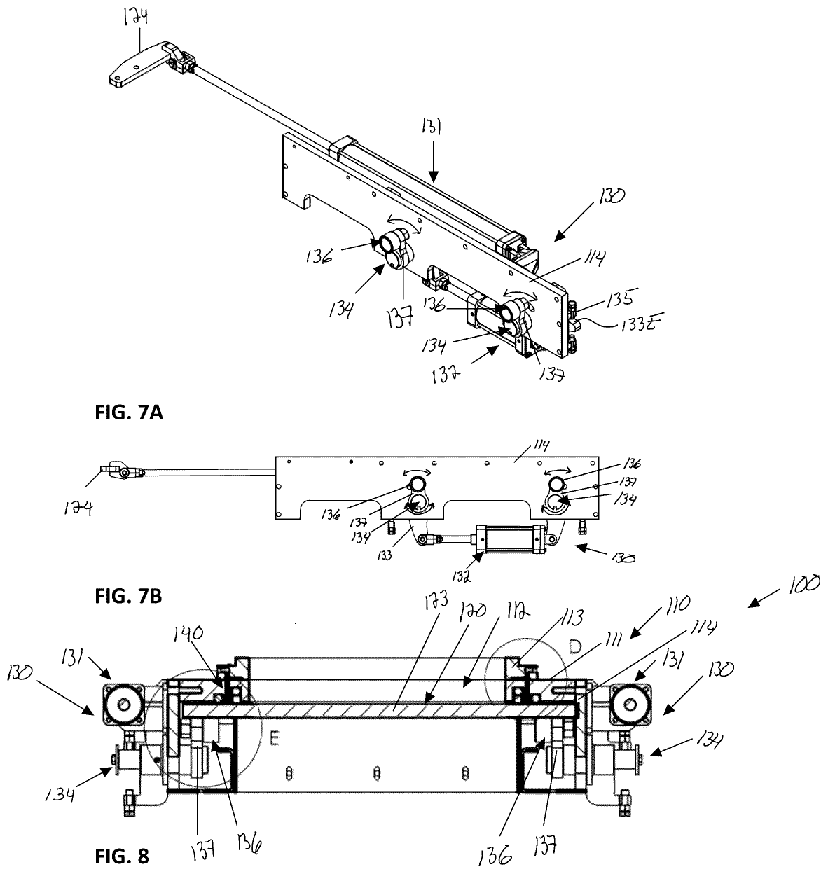

Referring to FIGS. 7A-7B, the actuation mechanism 130 includes pushers 136 that are configured to engage the closure member 120. The pushers 136 include rollers that are adapted to support the panel 123 as it moves between the open position and the closed position. When the valve 100 is in an unsealed configuration, the panel 123 may roll on the pushers 136 as it displaces along the displacement path 121. The pushers 136 are mounted to the pivot 134 of the respective linkages 133. In the embodiment shown, the pushers 136 have a rolling axis that is generally parallel with the pivot axis of the pivot 134. The rolling axis is offset with respect to the pivot axis. As shown, the pusher 136 is coupled to the pivot 134 via a lever 137. The lever 137 is an intermediary member extending between the pusher 136 and the pivot 134. The elongation of the actuators 132 pivot the linkages 133 about their respective pivot 134, thereby causing a rotation of the lever 137 about the pivot axis. The rotation of the lever 137 has a displacement vector component in a direction that is transverse to the panel 123. Stated otherwise, the rotation of the lever 137 about the pivot 134 causes a displacement of the pusher 136 in a direction that intersects with the panel 123. Referring to FIG. 8, as the pushers 136 that support the panel 123 are displaced towards the panel 123, such displacement of the pushers 136 may bias the panel 123 in a direction that is generally aligned with the discharge path 101. As part of the system 20 with the valve 100 mounted so as to have the discharge path 101 oriented vertically, and according to the orientation shown in FIG. 8, the panel 123 is pushed vertically against the seal arrangement 140.

In FIG. 8, the valve 100 is in the sealed configuration, with the panel 123 biased against the seal arrangement 140. The pushers 136 are engaged with the panel 123. The actuators 132 of the actuation mechanism 130 apply a load on the panel 123 via the linkages 133 and pushers 136 interfacing therewith. As the actuators 132 are released, the pushers 136 may unload the panel 123, thereby allowing the panel 123 to displace along the displacement path 121 by rolling on the pushers 136.

The seal arrangement 140 will now be described, referring to FIGS. 8-10. In the embodiment shown, the seal arrangement 140 includes a first seal 141 interfacing between the valve body 110 and the panel 123. In an embodiment the seal 141 is annular. The seal 141 may extend along a full periphery of the inlet opening 112 and/or opening 122 of the closure member 120 (and/or discharge path 101).

In an embodiment, the seal 141 is an elastomeric seal. The seal 141 is deformable as it is compressed between the valve body 110 and the closure member 120. In the embodiment shown, the seal 141 is mounted to the valve body 110. In the embodiment shown, the seal 141 is located in a recess of the valve body 110. The seal 141 is partially recessed in the recess of the valve body 110. The closure member 120 is thus movable with respect to the seal 141 and, as the valve 100 gains its sealed configuration, the closure member 120 may compress the seal 141. This could be reversed, in variants where the seal 141 is mounted to the closure member 120. In the seal configuration, the seal 141 contacts the valve body 110 and the closure member 120.

In the embodiment shown, the seal arrangement 140 is a dual seal arrangement. The seal arrangement 140 includes a second seal 142. In the embodiment shown, the second seal 142 is mounted to the valve body 110. In the embodiment shown, the second seal 142 is located in a recess of the valve body 110. The closure member 120 is thus movable with respect to the second seal 142 and, as the valve 100 gains its sealed configuration, the closure member 120 may compress the seal 142. In an embodiment the second seal 142 is annular (e.g., round elliptical or other annular shape). The second seal 142 may be concentric with the first seal 141. The second seal 142 may extend along a full periphery of the inlet opening 112 and/or opening 122 of the closure member 120. As shown, the second seal 142 is located closer to the discharge path 101 than the first seal 141 (i.e., the second seal 142 is disposed radially inwardly from the first seal 141 relative to a central axis of the opening 122). The second seal 142 may be an elastomeric seal similar as the first seal 141. For instance, both the first and second seals 141, 142 can be provided in the form of a O-ring having circular cross-section or other cross-sectional shape, such as elliptical.

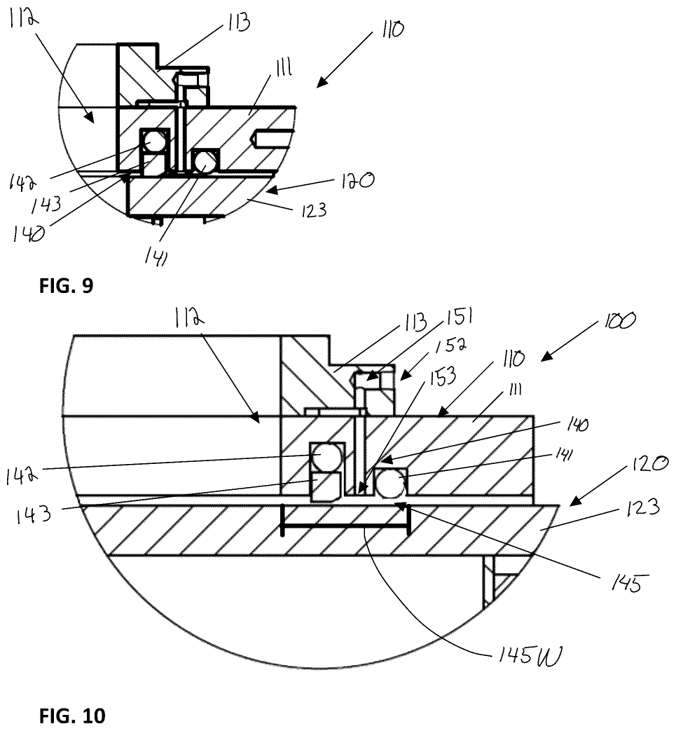

The second seal 142 acts as a biasing member that biases a ring 143 against the closure member 120. As shown, the ring 143 interfaces with the seal 142 and the closure member 120. The ring 143 may be coupled to the seal 142 or simply seated thereon. As illustrated in FIG. 9, the ring 143 is adapted to scrape the surface of the panel 123 as the closure member 120 transitions from the closed position to the open position (and vice versa). The ring 143 may be referred to as a scraper. With such scraping, debris in a sealing area 145 between the valve body 110 and the closure member 120 may be moved off prior to the sealing of the valve 100. This may limit accumulation of debris that could impact the sealing. The ring 143 may be in metal (e.g., steel), or material with high resistance to friction, corrosion and heat. As shown in FIG. 9, the ring 143 may have a square or another suitable cross-sectional shape to prevent relative movement between the ring 143 and the part in which it is received. For example, the ring 143 may have at least one sharp edge contacting the surface to be scraped. The ring 143 may be sized to slidingly fit within the part in which it is received. Other tolerancing could be contemplated.

Referring to FIG. 10, the sealing area 145 is defined between the valve body 110 and the closure member 120. The sealing area 145 extends along the periphery of the opening 122. The sealing area 145 has an annular shape (e.g., a circular, elliptical or other annularly shaped band around the opening 112 of the valve), with a width 145W extending along an interface of the panel 123 and the seal arrangement 140 (and/or valve body 110). The sealing area 145 includes the contact area between the seals 141, 142 and the closure member 120 (or valve body 110, in variants where the seals 141, 142 are coupled to the closure member 120). As identified in FIG. 10, the sealing area 145 extends outwardly from the periphery of the inlet opening 112 to the outwardmost end of the radially outwardmost seal 141.

With continued reference to FIG. 10, the valve 100 includes a gas conduit 151 fluidly connectable to a pressurized gas source and configured for impinging pressurized air against the sealing area 145 between the closure member 120 and the valve body 110. In the embodiment shown, the gas conduit 151 is defined through the base 111 and the ring 113 of the valve body 110. The gas conduit 151 has an inlet 152 defined by the ring 113 and an outlet 153, downstream of the inlet 152, and opened to the sealing area 145. In the embodiment shown, the outlet 153 is situated between the seals 141, 142 of the seal arrangement 140. Pressurized gas channeled through the gas conduit 151 may purge debris in the sealing area 145 to limit/avoid accumulation of debris in the sealing area 145 between the closure member 120 and the valve body 110 (base 111). As pressurized gas impinges against the closure member 120, debris and/or dust particles may be dislodged from underneath the seals 141, 142 and ring 143. Pressurized gas may have sufficient pressure to slightly elevate the ring 143 to disengage it from the closure member 120 so that small particles that could not be scraped by the ring 143 during the opening and closing of the closure member 120 may be flushed into the discharge path 101. The shape of the ring 143 may contribute to this. For example, in an embodiment, the pressurized gas may impinge on a bevel 143B at a bottom of the ring 143, thereby inducing an upward force on the ring 143 against the compressible seal 142). As shown, the bevel 143B faces towards the first seal 141. The pressurized gas discharged at the outlet 153 may impinge on the closure member 120, flow along the closure member 120 and impinge on the bevel 143B, thereby inducing an upward force onto the ring 143. Such upward force induced on the ring 143 may compress the second seal 142.

The pressurized gas may infiltrate the recess into which the seal 142 and ring 143 are engaged to avoid the clogging of such space over sealing and unsealing cycles. Similarly, particles underneath the seal 141 and in the recess into which the seal 141 is engaged may also be flushed by the pressurized gas infiltrating the recess. There may be a plurality of such gas conduit 151. As illustrated in FIG. 6, a plurality of gas conduits 151, are distributed along the periphery (e.g., circumference) of the inlet opening 112 (and/or discharge path 101). Four gas conduits 151, with their respective four inlets 152 defined in the ring 113 are shown, but this is only one possibility. Other configuration can be contemplated. For example, there could be more (or less) gas conduits 151. As another example, a plurality of gas conduits 151 may share a same inlet 152, and have multiple outlets 153 distributed along the periphery of the inlet opening 112. The pressure of the pressurized gas, number of gas conduits 151, outlets 153, and spacing therebetween along the periphery of the inlet opening 112 may be adjusted and/or vary depending on the embodiments, so as to produce more or less impingement and/or flushing.

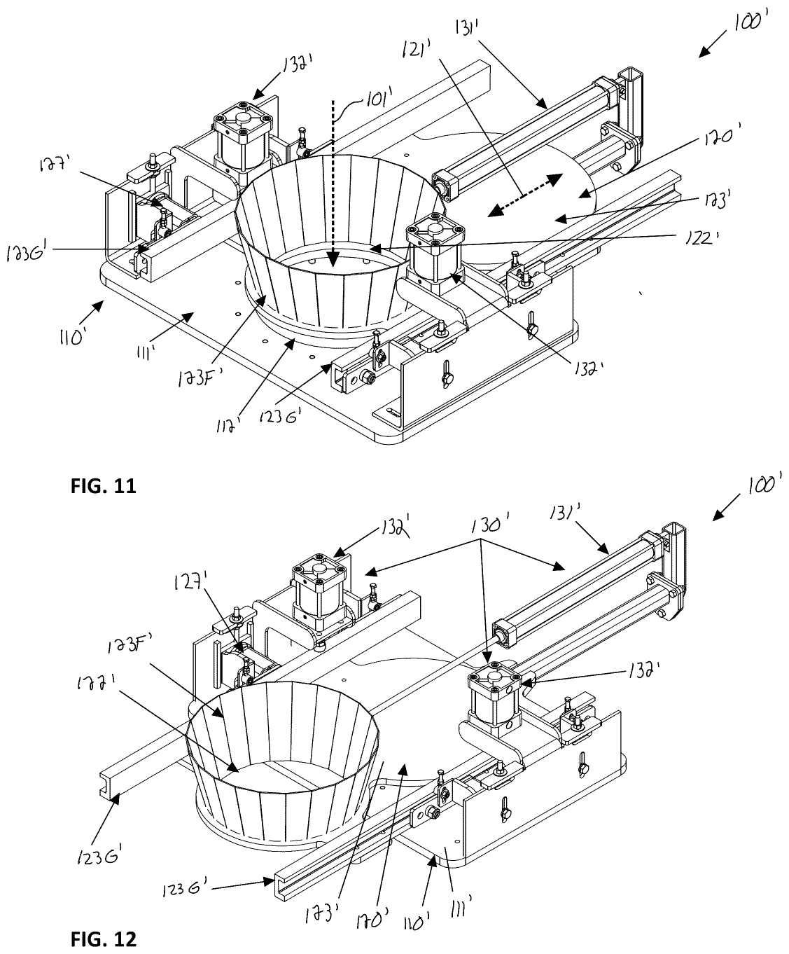

Referring to FIGS. 11-16, another embodiment of the valve 100 will now be described. Like features will bear the same references for simplicity. The valve 100′ shown in FIGS. 11-14 may selectively open and seal a port of the retort 30 of the system 20, as similarly described with respect to the valve 100 described above. The valve 100′ may be located upstream of the retort 30, such as the valve 40a. As part of the system 20, the valve 100′ may be referred to as the upper valve.

As shown, the valve 100′ includes a valve body 110′ and defines a discharge path 101′ and a closure member 120′ that is displaceable to open and close the discharge path 101′. The valve has an actuation mechanism 130′ operable to displace the closure member 120′ to open and close the discharge path 101′ and to bias the closure member 120′ against a seal arrangement 140′ and/or the valve body 110′ to seal the valve 100′. The valve body 110′ includes a plurality of parts, such as plates, channels, bars, brackets, etc. The parts of the valve body 110′ may be assembled via fasteners, welding, or the like. The valve body 110′ may be mounted to other components of the system 20, such as the kiln 22 or retort 30. In an embodiment, the valve body 110′ may be mounted at the inlet 40 of the retort 30 (the conduit or section of the retort 30 defining the inlet). The discharge path 101′ may thus be upstream of, and in continuity with, the inlet 40 of the retort 30. The valve body 110′ includes a base 111′. In the embodiment shown, the base 111′ is plate like. The valve body 110′ defines an inlet opening 112′, similarly as described above with respect to the valve 100.

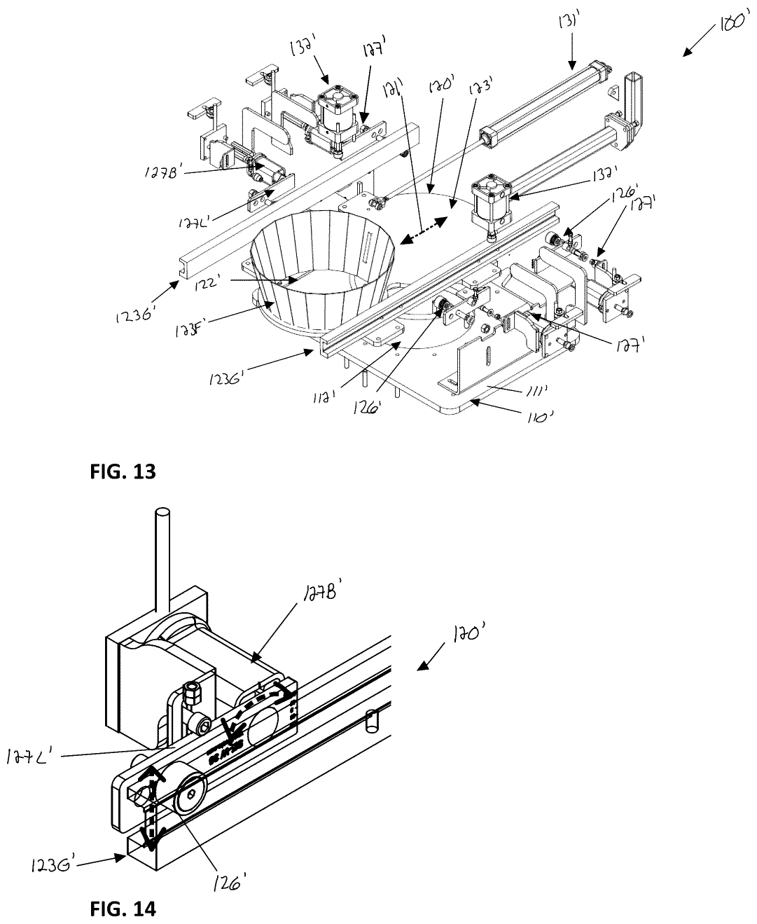

As shown in FIG. 13, the valve body 110′ includes a plurality of support rollers 126′. The support rollers 126′ are configured to support and guide the closure member 120′ as it displaces between the open position and the closed position. Features of the support rollers 126′ are shown in FIG. 14. As can be seen, the support roller 126′ in FIG. 14 engages a rail (guide 123G′, described later) of the closure member 120′. The support roller 126′ may roll along the rail as the closure member 120′ is displaced. The support roller 126′ is mounted to the valve body 110′ via a suspension unit 127′ adapted to provide freedom of movement of the support roller 126′ in a direction transverse to travel path along the rail. In the embodiment shown, the suspension unit 127′ includes a biasing member 127B′. In the embodiment shown, the biasing member 127B′ includes an elastomeric torsion spring. The elastomeric torsion spring may be a RunRight® rubber suspension commercialized by LoveJoy Inc., for example. This is only one possibility. The biasing member 127B′ may be coupled to the valve body 110′ via any suitable bracket. The support roller 126′ is coupled to the biasing member 127B′ via a lever 127L′. A load applied on the support roller 126′ in a direction transverse to the lever 127L′ may induce a torsion of the biasing member 127B′ about a torsion axis. As the actuation mechanism 130′ of the closure member 120′ is operated to seal the valve 100′, the actuation mechanism 130′ may oppose (and override) the load induced by the biasing member 127B′ to displace the closure member 120′ in a direction that is generally parallel to the discharge path 101′. In other configurations, the suspension unit 127′ could be configured to bias the closure member 120′ towards the base 111′, such that the biasing load induced by the actuation mechanism 130′ may be combined with a biasing load exerted by the biasing members 127B′ to act jointly instead of opposing to each other. The actuation mechanism 130′ will be further described later.

Returning to FIGS. 11-12, the closure member 120′ is operable to open and close the discharge path 101′. The closure member 120′ is displaceable with respect to the valve body 110′, along the base 111′ between an open position and a closed position along a displacement path 121′ transverse relative to the discharge path 101′.

In the embodiment shown, the closure member 120′ has an opening 122′. The opening 122′ generally aligns with the inlet opening 112′ when the closure member 120′ is in the open position. The opening 122′ may have the same cross-section (shape and/or dimension) as that of the inlet opening 112′. In the embodiment shown, the opening 122′ has a round shape. Other shapes could be contemplated (e.g., same shape or different shapes as that of the inlet opening 112′). In the embodiment shown, the closure member 120′ includes a generally flat panel 123′, or gate. The opening 122′ is defined through the panel 123′. The closure member 120′ includes a funnel 123F′. The funnel 123F′ is upstream of the opening 122′ in the panel 123′. The funnel 123F′ may channel the material discharged through the opening 122′. In the embodiment shown, the funnel 123F′ has a generally frustoconical shape. Other shapes could be contemplated, with one or more converging walls.

With continued reference to FIGS. 11-12 and additional reference to FIG. 13, the closure member 120′ includes guides 123G′ to guide the movement of the closure member 120′ of the valve 100′. In the embodiment shown, the guides 123G′ include rails that cooperate with the support rollers 126′ to guide the displacement of the closure member 120′ between the open position to a closed position. The guides 123G′ extend on opposite side of the panel 123′. The guides 123G′ are engaged with the plurality of support rollers 126′. The support rollers 126′ may roll along the rails as the closure member 120′ is displaced along the displacement path 121′. The closure member 120′ is suspended with respect to the valve body 110′ via the suspension units 127′ (FIGS. 13-14).

The actuation mechanism 130′ includes a plurality of actuators. The actuators are configured to displace the closure member 120′ along the displacement path 121′ and, in the closed position, to bias the closure member 120′ against a seal arrangement 140′ in a direction along the discharge path 101′. The actuation mechanism 130′ includes an actuator 131′ coupled to the valve body 110′ at one end and to the closure member 120′ at an opposite end. In operation the actuator 131′ operates to displace the closure member 120′ between the open position and the closed position, along the displacement path 121′.

In the embodiment shown, the actuator 131′ extends longitudinally in a direction that is generally parallel to the displacement path 121′. The actuation direction may thus be generally aligned with the displacement of the closure member 120′. The actuator 131′ may be mounted via a pivot with respect to the valve body 110′ and the closure member 120′ so as to allow a slight orientation changes of the actuator 131′ relative to the valve body 110′ and closure member 120′ as the closure member 120′ displaces along the displacement path 121′ and/or as it gains the sealed configuration, as will be described later.

In the embodiment shown, the actuator 131′ extends longitudinally between the guides 123G′. The actuator 131′ may be at an even distance from the opposite guides 123G′. Stated otherwise, the actuator 131′ is centered between the guides 123G′. Other configurations may be contemplated.

In FIG. 11, the closure member 120′ is in the open position. The open position of the closure member 120′ may be gained and/or maintained without pressurized gas supplied to the actuator 131′ by the pressurized gas source (not shown). The actuator 131′ may not apply any load on the closure member 120′ to maintain the closure member 120′ in the open position. This may be considered as a safety measure for the pyrolysis system.

As the actuation mechanism 130′ is operated to displace the closure member 120′ in the closed position, the closure member 120′ displaces along the displacement path 121′. The actuator 131′ extends in its extended position so as to displace the piston rod end of the actuator 131′. A corresponding displacement of the closure member 120′ is induced. In the embodiment shown, the linear displacement of the closure member 120′ from the open position to the closed position is directly correlated, with the elongation of the actuator 131′. A ratio of elongation of the actuator 131′ with respect to the displacement of the closure member 120′ along the displacement path 121′ is 1:1. Other ratios could be contemplated in variants of the actuation mechanism 130′. While a single actuator 131′ is shown in this embodiment, a plurality of actuators 131′ could be contemplated to displace the closure member 120′ along its displacement path 121′.

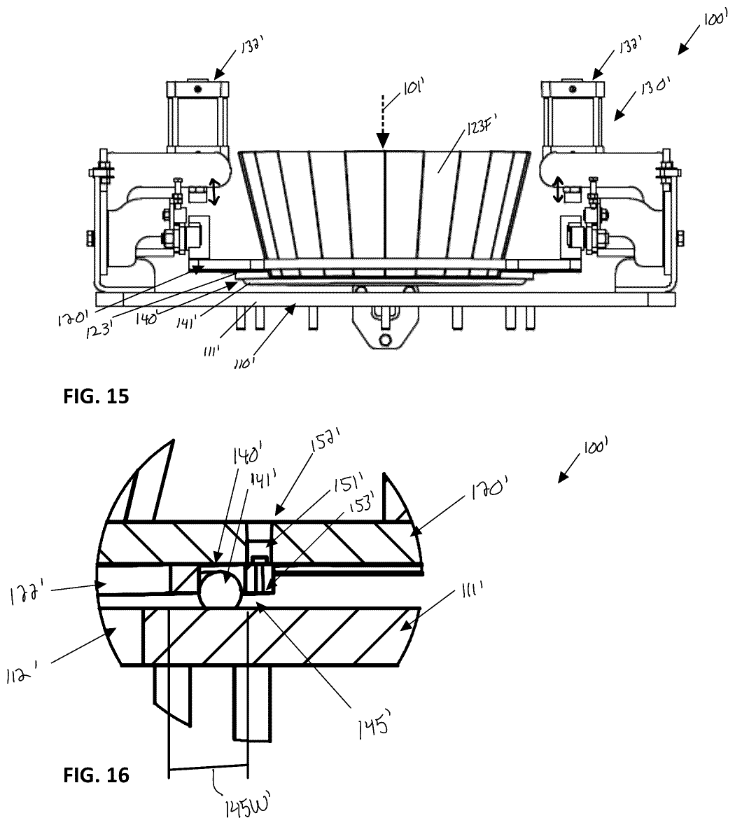

Similarly as described above with respect to the actuation mechanism 130 of the valve 100, the actuation mechanism 130′ is configured to bias the closure member 120′ against a seal arrangement 140′ in a direction along the discharge path 101′. The actuation mechanism 130′ includes actuators 132′, here a pair of actuators 132′, configured for biasing the closure member 120′ against the seal arrangement 140′ (FIGS. 15-16) and/or valve body 110′. In variants, as described later, there may be more actuators 132′, such as four, or even more. The actuators 132′ are located on opposite sides of the closure member 120′. In the embodiment shown, the actuators 132′ are oriented so as to extend in a direction that is parallel with the discharge path 101′. The orientation of the actuators 132′ is such that the vector of the biasing force is directly aligned with the biasing direction of the closure member 120′ against the seal arrangement 140′ and/or valve body 110′. The actuators 132′ may be operated simultaneously so as to bias the closure member 120′ against the seal arrangement 140′ and/or valve body 110′ (base 111′).

The actuators 132′ may be mounted to the valve body 110′ via any suitable bracket. The body of the actuators 132′ is fixedly coupled on the valve body 110′ with their piston rod end oriented towards the closure member 120′. More specifically, in the embodiment shown, the piston rod end of the actuators 132′ may contact the guides 123G′ of the closure member 120′ on opposite sides of the opening 122′ to apply a load thereon, on respective sides of the closure member 120′. There may be a direct contact between the piston rod end of the actuators 132′ and the closure member 120′, as shown, though intermediary components interfacing therebetween may be contemplated in variants.

Referring to FIGS. 15-16, in the valve 100′, the seal arrangement 140′ includes a single seal 141′. The seal 141′ interfaces between the valve body 110′ and the panel 123′. The seal 123′ is annular. The seal 141′ may extend along a full periphery of the inlet opening 112′ and/or opening 122′ of the closure member 120′.

In an embodiment, the seal 141′ is an elastomeric seal. The seal 141′ is deformable as they are compressed between the valve body 110′ and the closure member 120′. In the embodiment shown, the seal 141′ is mounted to the closure member 120′. In the embodiment shown, the seal 141′ is located in a recess of the closure member 120′.

The closure member 120′ is thus movable with the seal 141′ and, as the valve 100′ gains its sealed configuration, the closure member 120′ may compress the seal 141′ against the valve body 110′.

With continued reference to FIG. 16, a sealing area 145′ is defined between the valve body 110′ and the closure member 120′. The sealing area 145′ extends along the periphery of the opening 122′. The sealing area 145′ has an annular shape, with a width 145W′ extending along an interface of the valve body 110′ and the closure member 120′. The sealing area 145′ includes the contact area between the seal 141′ and the valve body 110. As identified in FIG. 16, the sealing area 145′ extends outwardly from the periphery of the opening 122′ to the outwardmost end of the seal 141′.

With continued reference to FIG. 16, the valve 100′ includes a gas conduit 151′ fluidly connectable to a pressurized gas source and configured for impinging pressurized air against the sealing area 145′ between the closure member 120′ and the valve body 110′. In the embodiment shown, the gas conduit 151′ is defined through the closure member 120′. The gas conduit 151′ has an inlet 152′ defined by the panel 123′ and an outlet 153′, downstream of the inlet 152′, and opened to the sealing area 145′. In the embodiment shown, the outlet 153′ is situated immediately outwardly from the seal 141′ of the seal arrangement 140′. Pressurized gas channeled through the gas conduit 151′ may purge debris in the sealing area 145′ to limit/avoid accumulation of debris in the sealing area 145′ between the closure member 120′ and the valve body 110′ (base 111′). As pressurized gas impinges against the base 111′, debris and/or dust particles may be dislodged from underneath the seal 141′.

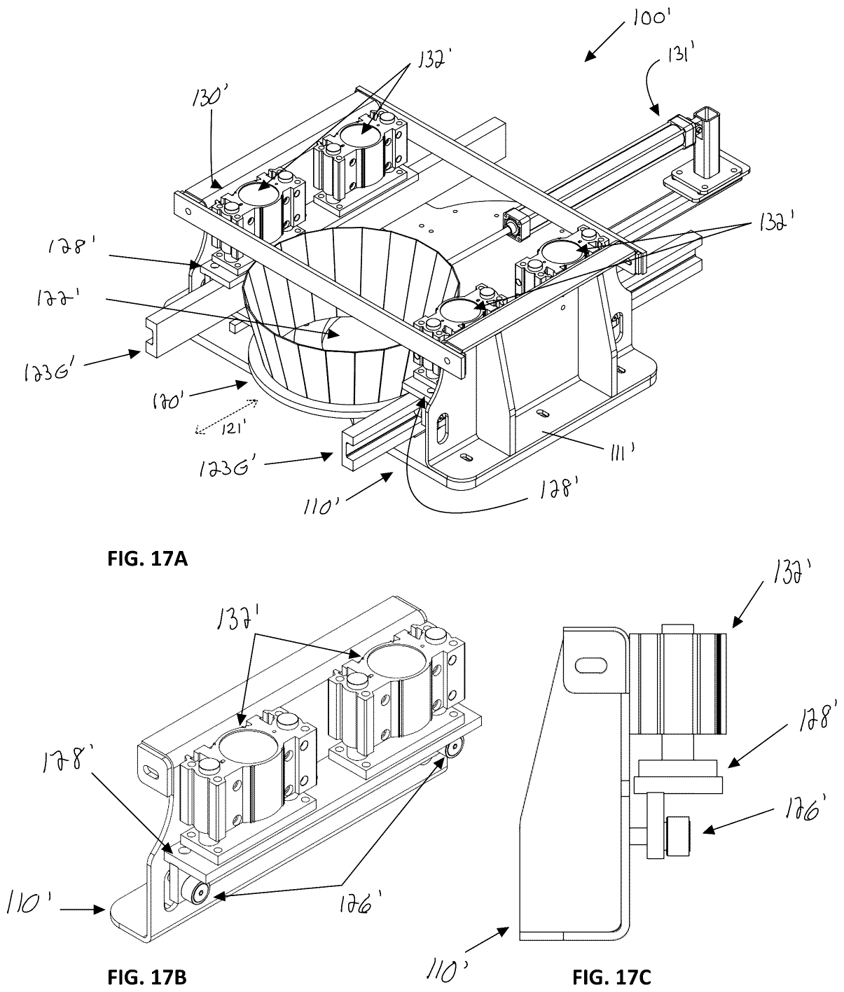

FIGS. 17A-17C illustrate a variant of the valve 100′. Like features will not be described again for brevity, but will bear the same reference numbers for ease of reference. As shown, the actuation mechanism 130′ includes an actuator 131′ like actuator 131 to displace the closure member 120′ along its displacement path 121′. The actuation mechanism 130′ also includes actuators 132′, here two pairs of actuators 132′, configured for biasing the closure member 120′ against the seal arrangement 140′ (FIGS. 15-16) and/or valve body 110′. The pairs of actuators 132′ are positioned on opposite sides of the opening 122′. The load applied by the four actuators 132′ is distributed along the sides of the opening 122′, over a distance that may be at least as long as the transverse dimension (e.g., diameter) of the opening 122′, for a more even load distribution to seal the valve 100′. The actuators 132′ may be mounted to the valve body 110′ via any suitable bracket. The body of the actuators 132′ is fixedly coupled on the valve body 110′ with their piston rod ends oriented towards the closure member 120′.

In the variant of FIGS. 17A-17C, the pairs of actuators 132′ are configured to displace the closure member 120′ in a direction transverse to the displacement path 121′, towards and away the base 111′. As shown, the closure member 120′ is supported by the support rollers 126′, which are coupled to the actuators 132′ via a support bracket 128′. The guides 123G′ are engaged with the plurality of support rollers 126′. The support rollers 126′ may roll along the rails of the guides 123G′ as the closure member 120′ is displaced along the displacement path 121′. The closure member 120′ is suspended with respect to the valve body 110′ via the pairs of actuators 132′. As shown, the support rollers 126′ are coupled to the bracket 128′ that are coupled to the piston rod end of the actuators 132′. In the variant shown, each pair of actuators 132′ are interconnected by one of the brackets 128′. Stated otherwise, each bracket 128′ on opposite sides of the opening 122′ are coupled to a respective pair of the actuators 132′. The actuation of the pairs of actuators 132′ may thus displace the support rollers 126′ engaged with the guides 123G′, thereby displacing the closure member 120′ between the sealed configuration and the unsealed configuration. The support bracket 128′ is coupled to the piston rod end of the actuators 132′. The piston rod end of the actuators 132′ may be in direct contact with the bracket 128′ or be coupled thereto via an intermediary component (e.g., plates, fixing brackets, etc.). The actuation of the actuators 132′, may cause a corresponding displacement of the support bracket 128′ in a direction transverse to the displacement path 121′. In the variant shown, the brackets 128′ have an L-shape profile, with one leg defining an interface with a respective pair of the actuators 132′, and the other leg extending laterally along the closure member 120′ and supporting the support rollers 126′. Other bracket configuration could be contemplated. The pairs of actuators 132′ may be operated simultaneously so as to bias the closure member 120′ against the seal arrangement 140′ (FIGS. 15-16) and/or valve body 110′ (base 111′). The biasing force produced by the actuators 132′ is transmitted to the closure member 120′ via the brackets 128′ and support rollers 126′ mounted thereto.

As it can be appreciated from the architecture of the valve 100, 100′ disclosed herein, the valve 100, 100′ may be easily disassemble to replace components or for maintenance. For example, over time, the ring 143, and seals 141, 141′, 142 may wear and/or get fatigued after repeated cycles in the harsh operating conditions. It may thus be desirable to disassemble easily and efficiently components of the valve 100, 100′ to gain access to the seals 141, 141′, 142 and ring 143, among others. Since the valve 100, 100′ may be mounted as part of the whole system 20, between pipe sections or other components of the system 20, it may be desirable to gain access to the parts to be replaced or for maintenance without having to remove the whole valve 100, 100′ from the system 20. The valve body 110 may thus remain in place as part of the system 20, and the closure member 120, 120′ removed from its insertion plane along its displacement path 121, 121′. In order to replace seals 141, 141′, 142 and/or ring 143 on site, an operator may disconnect the actuation mechanism 130, 130′ from the closure member 120, 120′.

In the embodiment shown in FIGS. 4-10, disconnecting the actuation mechanism 130 may include disconnecting the brackets 124 from the actuators 131, thereby leaving the closure member 120 free to displace along the displacement path 121 relative to the actuators 131. The closure member 120 may then be disengaged from the valve body 110, by displacing the closure member 120 along the guides 114 until the closure member 120 is fully disengaged therefrom. Once fully disengaged, the seals 141, 142 and ring 143 may be accessed from a side of the valve body 110. A side plate or bracket may be removed from the valve body 110 to increase a space for accessing the sealing area 145, however this is optional. Once the seals 141, 142 and/or ring 143 are freed from their respective recesses of the valve 100, replacement seals and/or a replacement ring may be put in place. The closure member 120 may then be reassemble into the valve body 110, with the guides 114, and the actuators 131 reconnected to the closure member 120.

In the embodiment shown in FIGS. 11-16, and variant of FIGS. 17A-17C, the closure member 120′ may be similarly disengaged from the valve body 110′. The actuator 131′ may be disconnected from the closure member 120′, thereby freeing the closure member 120′ to displace along the displacement path 121′. The guides 123G′ may be displaced along the displacement path 121′ beyond engagement with the support rollers 126′ to free the guides 123G′ from the support rollers 126′ and from the remainder of the valve body 110′. The seal 141′ may then disengaged from the recess of the closure member 120′ and replaced by a replacement seal before re-engaging the closure member 120′ with the valve body 110′.

The embodiments described in this document provide non-limiting examples of possible embodiments of the present technology. Upon review of the present disclosure, a person of ordinary skill in the art will recognize that changes may be made to the embodiments described herein without departing from the scope of the present technology.

What is claimed is:

1. A valve for a pyrolysis system, the valve configured for selectively opening and sealing a port of a retort chamber of the pyrolysis system, the valve comprising:
a valve body defining a discharge path;
a closure member operable to open and close the discharge path, the closure member displaceable with respect to the valve body between an open position and a closed position along a displacement path transverse relative to the discharge path;
a seal arrangement between the valve body and the closure member;
an actuation mechanism operatively engaged to the closure member, the actuation mechanism configured to displace the closure member between the open position and the closed position along the displacement path and, in the closed position, to bias the closure member against the seal arrangement and/or the valve body in a direction along the discharge path; and
a gas conduit fluidly connectable to a pneumatic system and configured for impinging pressurized air against a sealing area between the closure member and the valve body, the gas conduit having a gas inlet fluidly upstream of a gas outlet, the gas outlet opened to the sealing area.

2. The valve of claim 1, wherein the actuation mechanism includes:
at least a first actuator for causing a linear displacement of the closure member from the open position to the closed position along the displacement path, the first actuator coupled to the valve body at one end and to the closure member at an opposite end; and
at least a pair of second actuators configured to bias the closure member against the seal arrangement and/or the valve body in a direction along the discharge path.

3. The valve of claim 2, wherein the first actuator is part of a pair of first actuators, the pair of first actuators and the pair of second actuators are located on opposite sides of the closure member, the pair of first actuators and the pair of second actuators mounted to the valve body.

4. The valve of claim 2, wherein the first actuator extends longitudinally in a direction that is generally parallel to the displacement path.

5. The valve of claim 1, wherein the actuation mechanism includes a plurality of rollers operatively engaged to the closure member, the plurality of rollers in rolling engagement with the closure member as the closure member displaces with respect to the valve body between the open position and the closed position along the displacement path.

6. The valve of claim 5, wherein the closure member includes rails on opposite sides of the closure member, the rails cooperating with the plurality of rollers to guide the displacement of the closure member between the open position and the closed position, the rails engaged with the plurality of rollers.

7. The valve of claim 2, wherein the closure member is suspended with respect to the valve body via the pair of second actuators, in the open position.

8. The valve of claim 2, wherein the pair of second actuators is a first pair of second actuators, the actuation mechanism includes a second pair of second actuators, the first and second pairs of second actuators are located on opposite sides of the closure member, support brackets are located on opposite sides of the closure member, each support bracket coupled to a respective one of the first and second pairs of second actuators, wherein a plurality of rollers are coupled to the support brackets operatively engaged to the closure member.

9. The valve of any one of claim 2, wherein the pair of second actuators are pivotally engaged to linkages, the linkages pivotally mounted to the valve body and having a pivot axis normal to the displacement path, the pair of second actuators operable to pivot the linkages as the pair of second actuators are operated to bias the closure member against the seal arrangement and/or the valve body.

10. The valve of claim 9, wherein each second actuator of the pair of second actuators are mounted in a floating configuration between two of the linkages, a first end of each second actuator of the pair of second actuators is mounted to a respective one of the linkages, and a second end of each second actuator of the pair of second actuators is mounted to another respective one of the linkages.

11. The valve of claim 1, wherein the closure member includes a panel defining an opening therethrough, the opening aligned with an inlet opening of the valve body when the closure member is in the open position.

12. The valve of claim 2, wherein a ratio of elongation of the first actuator with respect to a displacement of the closure member along the displacement path from the open position to the closed position is 1:1.

13. A valve for a pyrolysis system, the valve configured for selectively opening and sealing a port of a retort chamber of the pyrolysis system, the valve comprising:
a valve body defining a discharge path;
a panel operable to open and close the discharge path, the panel displaceable with respect to the valve body between an open position and a closed position along a displacement path transverse relative to the discharge path;
a seal arrangement between the valve body and the panel, the seal arrangement including a scraper frictionally engaging at least one of the panel and the valve body in a sealing area about the discharge path during the displacement of the panel between the closed position and the open position;
an actuation mechanism operatively engaged to the panel to actuate the panel between the open position and the closed position; and
a gas conduit fluidly connectable to a pressurized gas source and configured for impinging pressurized gas against the sealing area to flush debris therefrom, the gas conduit having a gas inlet fluidly upstream of a gas outlet, the gas outlet opened to the sealing area.

14. The valve of claim 13, wherein the panel defines an opening therethrough, the opening aligned with an inlet opening of the valve body when the panel is in the open position.

15. The valve of claim 13, wherein the seal arrangement includes a first seal interfacing between the valve body and the panel, wherein the first seal is annular and extends along a full periphery of the discharge path, the first seal compressible between the valve body and the panel.

16. The valve of claim 15, wherein the seal arrangement includes a second seal closer to the discharge path than the first seal, the first seal and the second seal are concentric one with respect to the other.

17. The valve of claim 15, wherein the first seal is located in a recess of the valve body.

18. The valve of claim 15, wherein the sealing area has an annular shape, the sealing area extending outwardly from a periphery of the inlet opening to a radially outwardmost end of the first seal, the gas outlet is situated between the periphery of the inlet opening and the first seal.

19. The valve of claim 16, wherein the gas outlet is situated between the first seal and the second seal.

20. The valve of claim 13, wherein the scraper is biased towards the panel via a first seal of the seal arrangement, the first seal interfacing between the valve body and the scraper, the scraper including a ring located in a recess of the valve body, the ring extending about an inlet opening of the valve body, the first seal compressible between the ring and the valve body.
